(19) United States
(12) Patent Application Publication
(10) Pub. No.: US 2021/0180621 A1
(43) Pub. Date: Jun. 17, 2021

(54) VALVE ARRANGEMENT

(71) Applicant: HORCHER GMBH, Nidderau (DE)

(72) Inventor: Stefan HORCHER, Nidderau (DE)

(73) Assignee: HORCHER GMBH, Nidderau (DE)

(21) Appl. No.: 17/076,151

(22) Filed: Oct. 21, 2020

(30) Foreign Application Priority Data
Oct. 21, 2019 (DE) 10 2019 128 364.7

(51) Int. Cl. F15B 21/04; G05D 7/06; G05B 15/02

(52) U.S. Cl. CPC F15B 21/04; G05B 15/02; G05D 7/0647; G05D 7/0623

(57) ABSTRACT

The invention relates to a method and an assembly for controlling the discharge of a liquid from a fitting (10), wherein the liquid discharge can be shut off by means of a shut-off valve (12) which is actuatable via a codable electric control unit (14) when the temperature of the liquid would cause a hazard.

The invention relates to a method for controlling the discharge of a liquid from a fitting, particularly for the discharge of water from a thermostatic mixing valve or thermostatic mixing battery, comprising a control knob which interacts with a valve stem of a first valve, wherein the control knob has a first stop element or such originates therefrom, which interacts with a second or a third stop element or a stop device, which is or are arranged fixed in position as relates to the first valve, as a function of the position of the control knob, wherein the liquid discharged from the fitting
has a temperature T1 upon interaction of the first stop element with the second stop element,
has a temperature T2, where T2>T1, after the second stop element is overcome and the first stop element is interacting with the third stop element, and
has a temperature T3, where T3>T2, after the third stop element is overcome.

The subject matter of the invention is also a liquid valve assembly, particularly a thermostatic mixing valve or battery, comprising a control knob, interacting with a valve stem originating from a valve housing, having a first stop element adjustable with said control knob, which stop element interacts with second and third stop elements or stop devices arranged in a fixed position as relates to the valve housing or on the valve housing, in different rotational positions of the rotary knob.

In order to prevent scalding, it is customary to limit water fixtures to a maximum end temperature of about 42° C. However, this temperature carries the risk of microbial contamination with, e.g., Legionella bacteria, which makes it necessary to carry out a thermal disinfection, in which the liquid is flushed through the lines and the fitting at a temperature of, e.g., 70° C.

Mixing batteries having two stops are typically used in hospitals, nursing homes, or children's homes, wherein the temperature can be up to 38° C. when a first stop is reached and the temperature can be between 38° C. and 42° C. in the region between the first and the second stop. In order to carry out a disinfection, the second stop must be overcome. This is frequently done by opening the fitting in order to then manually adjust the control knob actuating the fitting such that flushing takes place at the temperature enabling disinfection.

The corresponding handling is associated with high labor requirements. In addition, there is the risk that the control knob may not be remounted properly to the extent that there is the risk of scalding upon use.

The subject matter of EP 1 903 268 A2 is a control knob for a water valve, which is attached to a valve stem originating from a valve housing in a movable manner and which has a fixed stop, which interacts with at least one stop arranged on the valve housing, wherein a stop is provided on the control knob, which stop is arranged concealed further outward and which is releasable from its stop position, wherein a device is provided for interacting with the control knob in order to displace the releasable stop from its stop position in order to release the internal limit. This device is arranged to be displaceable in the axial direction as relates to the control knob in order to release the stop.

A control knob of a fitting as per EP 0 778 434 A1 is arranged, in a rotationally fixed manner, on a valve stem with limited rotation and which originates from a valve housing, wherein a rotary stop, which is releasable by a user, is provided on the valve for the control knob. Furthermore, the control knob is arranged to have limited axial displacement on the valve stem and has at least one axial protrusion, which interacts with one or more stops of the valve housing such that the axial protrusion of the control knob is rotatable on the stop or stops, in the one axial end position.

The object upon which the present invention is based is to further refine a method and a valve assembly of the aforementioned type such that harmless use can occur and simultaneously there is the option of easily implementing a disinfection.

According to the invention, the object is achieved according to the method in that the liquid discharge is then shut off by means of a shut-off valve, as a second valve, which is actuated via a codable electric control unit when the liquid discharged by the first valve has the temperature T3, and in that the shut-off valve is only opened at temperature T3 when a specified code is entered into the control unit.

According to the invention, the third stop element and/or stop device, which is the second stop element or stop device immovably assigned to the valve housing, can consequently be controllably overcome in order to carry out disinfection without the risk of, for example, scalding occurring; a liquid discharge is suppressed by means of the electrically actuating shut-off valve, e.g. solenoid valve, when the liquid exiting from the valve has a temperature which could lead to a hazard. In this case, the temperature can be measured, for example in a tub inlet or in a shower inlet or showerhead or in a tub, by means of one or more sensors in order to impact the control unit for shutting off the second valve. Preferably, a temperature measurement can take place at several points in order to prevent a hazard, wherein a shut-off of the second valve takes place when an impermissible temperature is recorded at a sensor.

In a refinement of the invention, it is further provided that a warning sound beeps when the temperature reaches a critical range, which warning sound occurs intermittently at a temperature of 41° C. and beeps continually at a higher temperature of, e.g., 42° C.

If temperature T3 is reached, the shut-off valve is closed according to the invention so that the water supply is interrupted. In order to open the shut-off valve, a code must be entered, for example, on a touch panel or touch screen. After the code is entered, the continued water supply is enabled at increased temperatures, wherein the shut-off valve is automatically closed after a specified and/or adjustable timeframe.

Upon the next use of the fitting, the shut-off valve remains open or is only open when the temperature recorded by the one or more sensors is below critical temperature T3.

In particular, it is provided that the first stop element interacts with an insurmountable fourth stop element or stop device after the third stop element or device is overcome and upon a further actuation, such as turning, of the control knob.

In the following, the term “stop element” is always used even if it refers as well to a stop device such as an intermediate space.

Preferably, the first stop element connected to the control knob is adjusted radially in the direction of the valve stem in order to overcome the second stop element, i.e. the first stop element immovably assigned to the valve.

In order to bypass the third stop element, the first stop element is adjusted both radially and axially.

A liquid valve assembly of the aforementioned type is characterized in that an electrically actuatable shut-off valve is assigned to the valve assembly as a second valve, which is connected to a control unit, by means of which the shut-off valve can be automatically shut off when the temperature of the liquid in the outlet region and/or in a receptacle collecting the liquid exceeds a specified temperature T3, and in that the shut-off valve remains closed when there is no entering of a specified code into the control unit, provided a temperature T, where T≥T3, continues to prevail in the liquid.

If the third stop element, which is the second stop element immovably assigned to the valve, is overcome and thus a temperature can prevail at the outlet of the valve assembly which can lead to a hazard, the liquid inflow through the shut-off valve, which is preferably a solenoid valve, is automatically shut off. In order to carry out disinfection regardless of this, a code must be entered into the control unit in order to reopen the shut-off valve. After completion of disinfection or after the shut-off valve is again automatically shut off, the control knob is rotated back after a predefined time in order to shut off the first valve or to adjust it such that permissible temperatures prevail. The shut-off valve is opened after a previously programmed time or through the input of a code. When the sensors then record a temperature upon the liquid inflow which is below the hazard level, the shut-off valve thus remains open and a customary use of the valve assembly is enabled.

In particular, it is provided that the valve assembly has a fourth stop element which is immovably assigned to the valve housing and which can be overcome by the first stop element.

Thus, the invention is particularly characterized in that the valve assembly has a total of three stops immovably assigned to the first valve, wherein liquid has an outlet temperature which enables a disinfection upon the adjustment between the immovable second and third stop, i.e. the third and fourth stop element.

In particular, it is provided that the first stop element is formed to be radially adjustable via a spring-preloaded actuating element originating from the control knob for overcoming the second and third stop element.

Furthermore, it should be emphasized that at least the second and the third stop element originate from a base structure penetrated by the valve stem and coaxially surrounding it and connected to the valve housing or forming a section therefrom, which base structure should have an upper side with a ring geometry, wherein the second stop element is a first end surface of a first annular or hollow cylinder casing section originating from the upper side and extending coaxially as relates to the valve stem, and/or the third stop element is formed by an intermediate space extending coaxially as relates to the second annular or hollow cylinder casing section, which extends between a second end surface of the first hollow cylinder casing section and a first end surface of a second annular or hollow cylinder casing section extending coaxially as relates to the valve stem.

The end surfaces should extend perpendicular or diagonal as relates to the plane spanned by the upper side.

The inner sides of the hollow cylinder casing sections in this case provide guide surfaces for the first stop element originating from the control knob upon a rotation of the control knob.

It is provided in refinement that the second hollow cylinder casing section has, as the fourth stop element, i.e. the third immovable stop, a section which is angled or offset in the direction of the stem in its end region positioned remotely as relates to its first end surface.

In this case, the inner surface of the second hollow cylinder casing section also serves as the guiding surface during adjustment of the first stop element.

In order to prevent an unintentional overcoming of the third stop element, it is provided that a radially extending protrusion originates from the inner side of the second hollow cylinder casing section and in the region of its first end surface, the height of said protrusion extending in the axial direction of the base structure preferably being less than the height of the second hollow cylinder casing section. Thus, not only a radial adjustment of the first stop element is necessary, but also the control knob must be moved axially away from the valve housing. In other words, it is provided that the first stop element is adjusted radially in the direction of the stem and axially in order to overcome the protrusion.

Further details, advantages, and features of the invention result not only from the claims, the features to be taken from said claims—on their own and/or in combination—as well as the preferred exemplary embodiment to be obtained from the following description of the drawing.

The following is shown:

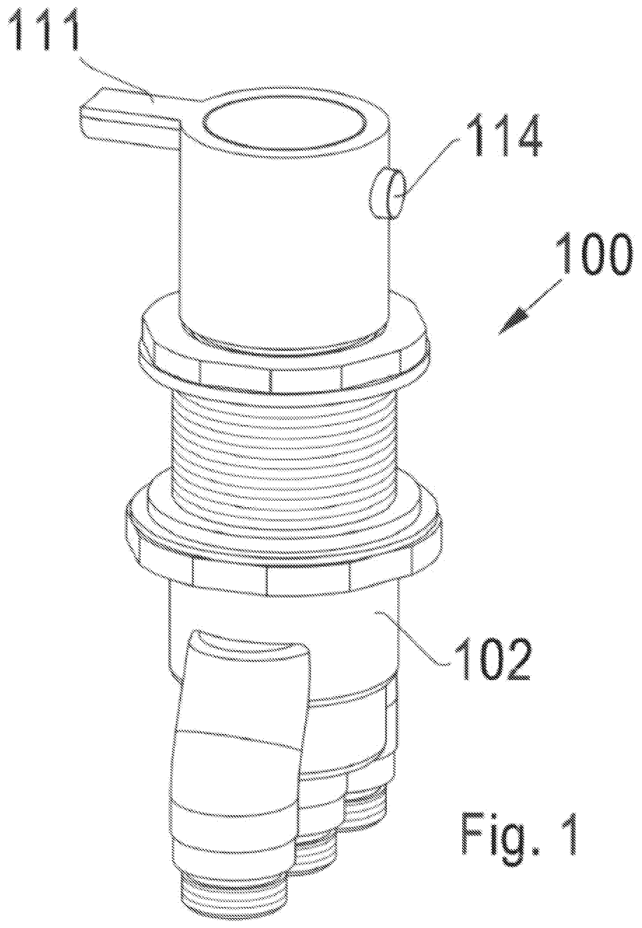

FIG. 1 a valve assembly;

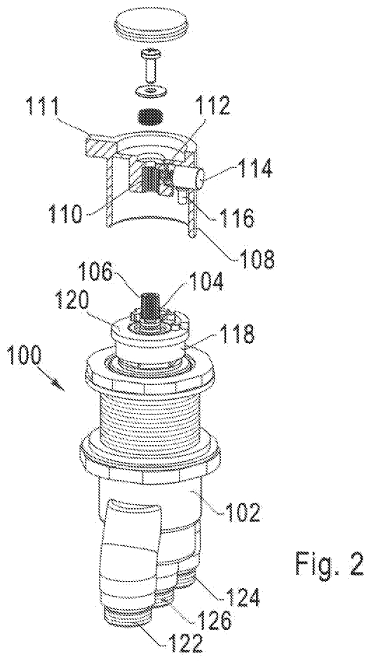

FIG. 2 the valve assembly according to FIG. 1 in an exploded view;

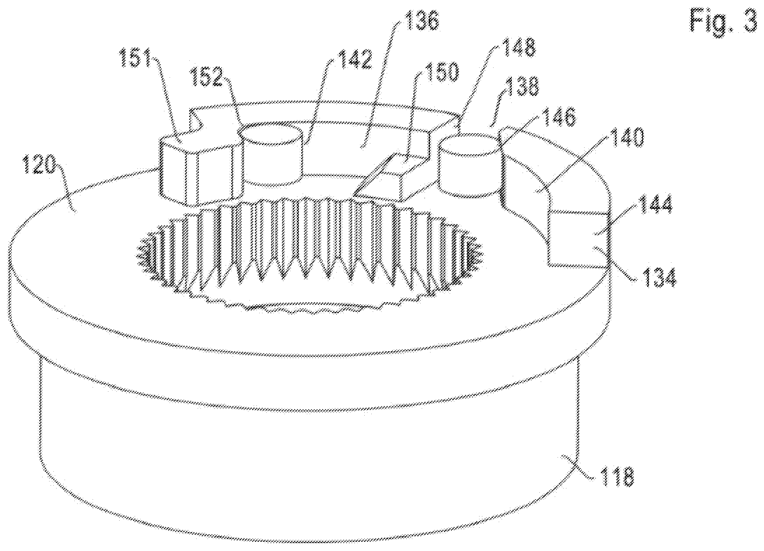

FIG. 3 an annular body with stop elements;

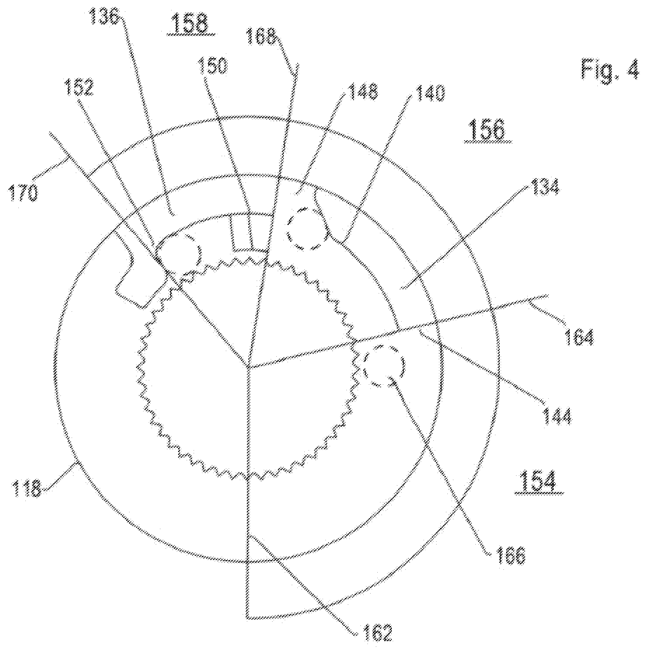

FIG. 4 a schematic representation of the annular body in a top view with stop elements;

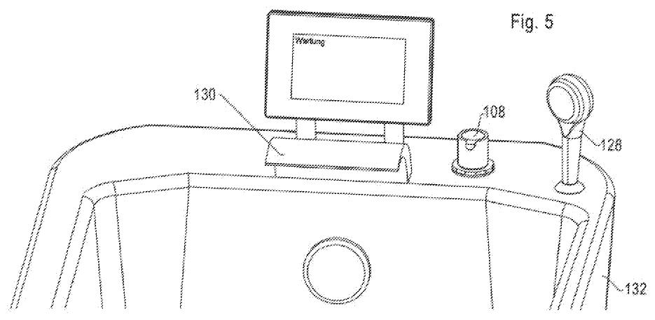

FIG. 5 a section of a bathtub with touch panel;

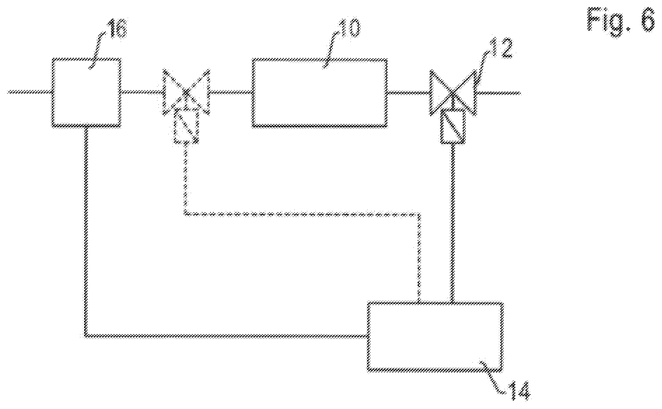

FIG. 6 a schematic representation of the valve assembly with shut-off valve; and

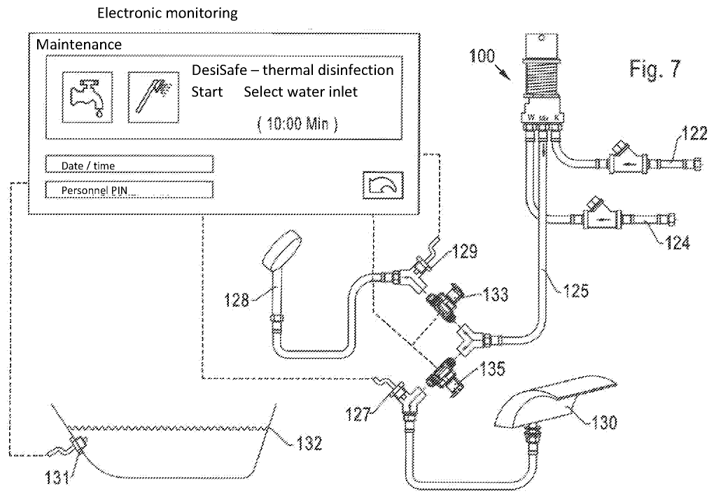

FIG. 7 an installation diagram.

The teaching according to the invention is explained by means of the figures; based on said teaching, a thermal disinfection of a water fitting can take place at temperatures of, e.g., 60° C. to 70° C. without the risk of scalding during normal operation of the fitting.

To this end, it is provided according to the invention that an electrically actuatable shut-off valve 12 is arranged in the inlet or outlet of a valve assembly 10, which shut-off valve then automatically shuts off when a temperature is recorded, via one or more sensors 16, in the outlet region of the valve assembly 10 and/or in a region, in which liquid is collected, which is above a permissible temperature, i.e. particularly above 42° C. In order to carry out a disinfection regardless of this, i.e. in order to reopen the shut-off valve 12, a code must be entered, e.g. via a touch panel, based on which the shut-off valve 12 is opened via a control unit 14. The sensor or sensors in this case may be provided, for example, in the inlet of a bathtub or in a showerhead and/or a supply line to a showerhead and/or in a bathtub itself.

The valve assembly 10 in this case makes it possible that water can be discharged in various temperature ranges due to the interaction of stop elements, which are to be described in greater detail in the following, wherein the range can also be adjusted without changes to the valve assembly in that a thermal disinfection is implemented.

FIGS. 1 and 2 show a valve assembly 100. A rotatable valve stem 104 with groove toothing 106 protrudes from a valve housing 102 of a particularly thermostat-controlled water-mixing valve in order to be connected, in a rotationally fixed manner, to a control knob 108, which has toothing 110 corresponding to the grooving 106.

A handle 111 for turning the adjusting knob 108 protrudes laterally from the adjusting knob 108, which is basically formed as a cylinder head. Furthermore, an actuating element 114, which is pretensioned by means of, e.g., a spring 112, is provided protruding radially, with the first stop element 116 originating from the actuating element, with the stop element interacting with the further stop elements immovably assigned to the valve and described in greater detail in the following. These stop elements originate from an annular and/or hollow-cylinder-shaped base structure 118, and specifically its upper side 120 extending perpendicular as relates to the longitudinal axis of the stem 104. The base structure 118 in this case is likewise immovably connected to the housing 102 via toothing.

The upper side 120 can be formed by an annular disk which is the headwall of the base structure 118.

In the present application, the term “stop element” also includes stop device or other means, by means of which the rotational movement of the control knob 108 is limited.

Cold water and hot water supply lines 122, 124 as well as a discharge line 126, which is connected, e.g., to the pipe of a showerhead 128 and/or to an inlet 130 of a bathtub 132, are connected to the valve housing 102.

Alternatively, the shut-off valve may also be provided in the discharge line of the valve assembly 10, as is indicated by the dashed lines shown in FIG. 6.

In order to obtain water of different temperature ranges, the first stop element 116, which is connected to the rotary knob 108, interacts with stop elements of the annular body 118 immovably connected to the valve assembly 100, as is shown by means of FIG. 3.

The first stop element 116 extends particularly in the axial direction of the valve housing 102 and may have the shape of a pin, such as a cylinder section.

Two annular sections, which are spaced apart from one another and thus have an intermediate space 138 available, which extend coaxially as relates to the longitudinal axis of the base structure 118 and thus of the stem 104 and which are also characterized as the first and second hollow cylinder casing sections 134, 136, originate from the upper side 120 of the base structure 118 extending perpendicular as relates to the longitudinal axis of the stem. The inner sides 140, 142 of the annular sections 134, 136 likewise extend coaxially as relates to the longitudinal axis of the base structure 118 and serve as a guiding surface for the first stop element 116, shown purely schematically, which is shown in three positions in FIG. 3.

The first annular section 134 has a first end surface 144, which extends radially as relates to the stem axis and perpendicular as relates to the plane spanned by the upper side 120.

This first end surface 144 forms a second stop element, which is a first stop element or a first stop, which is positioned immovably in the valve assembly 100.

The intermediate space 138 between the first and the second annular or hollow cylinder casing section 134, 136 forms a third stop element, which is a second stop element which is immovably arranged. Consequently, the intermediate space 138 is delimited by the second end surface 146 of the first annular section 134 and by the opposite-facing first end surface 148 of the second annular section 136. In this case, the second end surface 146 extends at an obtuse angle as relates to the inner surface 140 of the first annular section 134 such that a diagonal is formed which enables the rotary knob 108 to be turned back with low-friction if the rotary knob 108 is rotated clockwise, as in the exemplary embodiment.

Furthermore, an inwardly protruding protrusion 150, which is to be characterized as a cam, originates from the first end surface region of the second annular section 136, the height of the protrusion extending in the longitudinal direction of the annular body 118 being less than the height of the annular section 136 itself.

The second annular section 136 is angled inward (section 151) in its region which is remote from the first end surface 148 in order to thus form a further, i.e. fourth, stop element for the stop 116 originating from the control knob 108, in the transition region 152. The fourth stop element, which is the third immovable stop element, is thus formed by an end section of the annular section 136 which is inwardly offset.

Thus, the annular body 118 has three stop elements, namely the first end surface 144 of the first annular section 134, the intermediate space or gap 138 formed by the end surfaces 146, 148 of the first and second annular section 134, 136, as well as the region 152 extending through angled region of the second annular section 136, as a second, third, and fourth stop element.

FIG. 4 shows three regions 154, 156, 158 in reference to the base structure 108 and/or the annular disk 120 such that when the first stop element 116 originating from the control knob 108 is situated in these regions, the water flowing from the outlet has temperatures deviating from one another.

When the valve is closed, the first stop element 116 is situated in the region of the line 162. If the control knob 108 is turned counter-clockwise up to line 164, the first stop element 116 reaches the first second stop element 144 originating from the annular disk 120, said second stop element being the first end surface of the annular section 134. In the region 154 up to the second stop element 144, water between cold and, e.g., a maximum of 38° C. (T1) is discharged by the valve assembly.

In order to reach a higher temperature, the stop element which is formed by the end surface 144 of the first annular section 134 and designated as the second stop element must be overcome. To this end, the first stop element 116 is moved radially inward due to the pressing of the actuating element 114 into the control knob 108 (dashed circle 166 in FIG. 4) such that further rotation of the control knob 108 is possible. In this case, when the actuating element 114 is released, the first stop element 116 is guided along the inner surface 140 of the first annular element 134 in a sliding manner A rotation of the control knob 108 continues to be possible until the stop element 116, which is forced outward from impact due to the effect of the spring 112, slides into the gap or intermediate space 148 between the first and the second annular element 134, 136, i.e. engages the stop characterized as the third stop element. Further rotation beyond the third stop (line 168) is not possible. The temperature of the water in this region 156 between the second and third stop is typically between 38° C. and 42° C. (T2) as a function of the position of the control knob 108.

Basically, the second stop element which immovably originates from the base structure 118 and/or the annular disk 120, which is characterized as the third stop element 148, cannot be overcome by means of turning the control knob 108. In the event of an axial—upward in the figure—adjustment, the cam 150 can be overcome if the first stop element 116 is simultaneously adjusted inward. In this case, the valve would be opened in a scope such that temperatures of more than 42° C. to 60° C., e.g. 70° C. (T3), would prevail and thus there would be a risk of scalding.

In order to prevent this in a controlled manner, the shut-off valve 12 is provided according to the invention which closes via the control unit 14, provided the sensors 16 record temperatures, e.g., of above 42° C. However, an opening of the shut-off valve 12 is possible when a code is entered into the control panel by a person authorized to do this so that the thermal disinfection can take place.

If the control knob 108 in the exemplary embodiment is turned clockwise and thus the valve reaches a position in which water of a permissible temperature flows out, this is recorded by the sensor or sensors such that the shut-off valve 12 remains open via the control unit 14 and thus a normal use of the mixing battery is possible. Of course, the shut-off valve must be opened beforehand, whether it be programmed to do so or upon the entry of a code.

Line 168 is intended to show the position in which the first stop element 116 basically engages the third stop element 148 and which indicates the maximum permissible adjustment range for the mixing valve. The range in which the disinfecting temperature can be reached is limited by straight lines 168, 170, wherein straight line 170 indicates the position in which the first stop element 116 is insurmountably adjacent the third stop element 152, which is characterized as the fourth stop element, and which is immovably originating from the base structure 118.

The valve assembly 100 with the stop elements and/or stop devices 116, 138, 144, 152 has independent protection and is inherently inventive.

FIG. 7 shows, purely schematically, an installation diagram, based on which it is ensured that a disinfection of the valve assembly 100 can take place without, for example, the bathtub 132 being filled with water or water exiting from the showerhead 128 which has a temperature which represents a risk of scalding.

The valve assembly 100 is connected to lines 122, 124 in order to supply hot and cold water. A line 125, in which the water has the temperature set via the valve assembly, originates from the connection 126 of the valve assembly.

In order to ensure that the water has a permissible temperature, sensors 127, 129, 131 are arranged in the supply lines to the showerhead 128 and the water inlet to the bathtub 132 as well as a sensor 131 arranged in the bathtub 132 itself. These sensors are connected, for example, to a microprocessor in the control unit in order to then close the solenoid valves or other equivalent electrically actuatable valves arranged in the supply lines to the bathtub 132 and/or the showerhead 128 when an impermissibly high temperature is recorded.

If corresponding shut-off valves 133, 135 are provided on the outlet side, corresponding valves may obviously also be provided in the supply lines to the valve assembly 100 or in the connections of these supply lines.

1. A method for controlling the discharge of a liquid from a fitting (10, 100), particularly for the discharge of water from a thermostatic mixing valve or thermostatic mixing battery, comprising a control knob (108) which interacts with a valve stem (104) of a first valve, wherein the control knob has a first stop element (116) or such originates therefrom, which interacts with a second or a third stop element or a stop device (144, 138), which are immovably assigned to the first valve, as a function of the position of the control knob, wherein the liquid discharged from the fitting
has a temperature T1 until the interaction of the first stop element with the second stop element or stop device,
has a temperature T2, where T2>T1, after the second stop element or stop device is overcome and until the first stop element is interacting with the third stop element or device, and
has a temperature T3, where T3>T2, after the third stop element or stop device is overcome,
characterized in that
the liquid discharge is then shut off by means of a shut-off valve (12), as a second valve, which is actuated via a codable electric control unit (14) when the liquid discharged by the first valve has the temperature T3, and in that the shut-off valve is only re-opened at temperature T3 when a specified code is entered into the control unit.

2. The method according to claim 1,
characterized in that
the first stop element (116) interacts with an insurmountable fourth stop element or stop device (152) after the third stop element or stop device (138) is overcome and upon a further actuation, such as turning, of the control knob (108).

3. The method according to claim 1,
characterized in that
the first stop element (116) is adjusted radially for overcoming the second stop element or stop device (144) and/or the first stop element is adjusted both radially and axially by means of the control knob for overcoming the third stop element or stop device (138).

4. The method according to claim 1,
characterized in that
the temperature of the liquid flowing out of the fitting, for example in a line connecting the fitting to a liquid outlet, such as a tub outlet or showerhead, and/or in a liquid-collecting device collecting the liquid, such as the shower or tub (132), at least one temperature sensor (122, 129, 131) is arranged which is connected to a control unit (14), by means of which the shut-off valve (12) is controlled.

5. A liquid valve assembly (10, 100), particularly a thermostatic mixing valve or battery, comprising a control knob (108) interacting with a valve stem (104) originating from a valve housing (102) of a first valve, with an adjustable first stop element (116), which interacts with second and third stop element or stop device (144, 138) immovably assigned to the valve housing, in different rotary positions of the rotary knob,
characterized in that
an electrically actuatable shut-off valve (12) is assigned to the valve assembly (10, 100), which is connected to a control unit (14), by means of which the first valve can be automatically shut off when the temperature of the liquid in the outlet region and/or in a receptacle (132) collecting the liquid exceeds a specified temperature, and in that the shut-off valve remains closed when there is no entering of a specified code into the control unit, provided a temperature T, where T T3, continues to prevail in the liquid.

6. The assembly according to claim 5,
characterized in that
the valve assembly (10, 100) has a fourth stop element or stop device immovably assigned to the valve housing (102) and insurmountable by the first stop element (116).

7. The assembly according to claim 5,
characterized in that
the first stop element (116) is formed to be radially adjustable via a spring-preloaded actuating element (114) originating from the control knob (108) for overcoming the second and third stop element or stop device (144, 138).

8. The assembly according to claim 5, characterized in that
at least the second and the third stop element or stop device (144, 138) originate from a base structure (118) penetrated by the valve stem (104) and coaxially surrounding it and connected to the valve housing (102) or forming a section therefrom, which base structure has an upper side (120) with a ring geometry, wherein the second stop element or stop device (144) is a first end surface of a first annular or hollow cylinder casing section (134) originating from the upper side and extending coaxially as relates to the valve stem, and/or the third stop element or stop device (148) is formed by an intermediate space extending coaxially as relates to the second ring or hollow cylinder casing section (136), which extends between a second end surface (146) of the first ring or hollow cylinder casing section and a first end surface (148) of a second annular or hollow cylinder casing section (136) extending coaxially as relates to the valve stem.

9. The assembly according to claim 8,
characterized in that
the second annular or hollow cylinder casing section (136) has a section angled in the direction of the stem (104), as the fourth stop element (152), in its end region (150) which is remote as relates to its first end surface (148).

10. The assembly according to claim 5,
characterized in that
a radially extending protrusion (150) originates from the inner side (142) of the second annular or hollow cylinder casing section (136) and extending in the region of its first end surface (148), the height of said protrusion extending in the axial direction of the base structure (118) preferably being less than the height of the second hollow cylinder casing section.

11. The assembly according to claim 10, characterized in that
the first stop element (116) is adjusted radially in the direction of the stem (104) and axially in order to overcome the protrusion (150).

12. The assembly according to claim 8, characterized in that
the inner surfaces (140, 142) of the annular or hollow cylinder casing sections (134, 136) extending on the stem side are a guide surface for the first stop element (116) during the rotary adjustment of the control knob (108).

13. The assembly according to claim 5, characterized in that
the liquid valve assembly (10, 100) is connected to a liquid discharge device (128, 130), such as a showerhead or tub outlet, via a line (125), and in that at least one temperature sensor (122, 129, 131) is arranged upstream of the liquid discharge device and/or in a liquid-collecting device, such as a shower or bathtub (132), said temperature sensor being connected to a control unit (14) for controlling the shut-off valve (12).
